(19) United States
(12) Patent Application Publication
(10) Pub. No.: US 2024/0256932 A1
(43) Pub. Date: Aug. 1, 2024

(54) QUBIT PROCESSING METHOD, COMPUTER READABLE STORAGE MEDIUM AND APPARATUS

(71) Applicant: Alibaba Damo (Hangzhou) Technology Co., Ltd., Hangzhou, Zhejiang (CN)

(72) Inventors: Tenghui WANG, Hangzhou, Zhejiang (CN); Gengyan ZHANG, Hangzhou, Zhejiang (CN); Xianchuang PAN, Hangzhou, Zhejiang (CN)

(21) Appl. No.: 18/508,655

(22) Filed: Nov. 14, 2023

(30) Foreign Application Priority Data
Nov. 16, 2022 (CN) 202211435240.5

(51) Int. Cl. G06N 10/20

(52) U.S. Cl. CPC G06N 10/20

(57) ABSTRACT

A qubit processing method includes: acquiring values of dephasing factors corresponding to a plurality of first predetermined evolution durations after a qubit is respectively evolved for the plurality of first predetermined evolution durations from a predetermined initial state; and determining a decoherence time of the qubit based on the plurality of first predetermined evolution durations and the values of the dephasing factors corresponding to the plurality of first predetermined evolution durations.

### CROSS-REFERENCE TO RELATED APPLICATIONS

The disclosure claims the benefits of priority to Chinese Application No. 202211435240.5, filed on Nov. 16, 2022, which is incorporated herein by reference in its entirety.

### TECHNICAL FIELD

The present disclosure relates to quantum technology, and more particularly, to a qubit processing method, a computer readable storage medium, and an apparatus.

### BACKGROUND

The measurement of decoherence time of qubits is the basis for studying a decoherence mechanism. The spectrum measurement of the qubits is also helpful to the study of decoherence, and at the same time, relevant parameters of a chip can be deduced by the spectrum measurement of the qubits, which is an indispensable part of optimizing a micro-nano processing process. In related technologies, Ramsey measurement is usually used for calibrating the decoherence time, and long microwave excitation is used for performing frequency sweep measurement. These measurements require many data points and take a long time, which is not conducive to rapid calibration and decoherence studies of the system.

### SUMMARY OF THE DISCLOSURE

Embodiments of the present disclosure provide a qubit processing method. The qubit process method includes: acquiring values of dephasing factors corresponding to a plurality of first predetermined evolution durations after a qubit is respectively evolved for the plurality of first predetermined evolution durations from a predetermined initial state; and determining a decoherence time of the qubit based on the plurality of first predetermined evolution durations and the values of the dephasing factors corresponding to the plurality of first predetermined evolution durations.

Embodiments of the present disclosure provide a non-transitory computer readable medium that stores a set of instructions that is executable by one or more processors of an apparatus to cause the apparatus to perform operations. The operations include: acquiring values of dephasing factors corresponding to a plurality of first predetermined evolution durations after a qubit is respectively evolved for the plurality of first predetermined evolution durations from a predetermined initial state; and determining a decoherence time of the qubit based on the plurality of first predetermined evolution durations and the values of the dephasing factors corresponding to the plurality of first predetermined evolution durations.

Embodiments of the present disclosure provide an apparatus for qubit processing, the apparatus includes a memory configured to store instructions; and one or more processors configured to execute the instructions to cause the apparatus to perform: acquiring values of dephasing factors corresponding to a plurality of first predetermined evolution durations after a qubit is respectively evolved for the plurality of first predetermined evolution durations from a predetermined initial state; and determining a decoherence time of the qubit based on the plurality of first predetermined evolution durations and the values of the dephasing factors corresponding to the plurality of first predetermined evolution durations.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 shows a hardware structure block diagram of an example computer terminal for implementing a qubit processing method, according to some embodiments of the present disclosure.

FIG. 2 is a flowchart of a first exemplary qubit processing method, according to some embodiments of the present disclosure.

FIG. 3 is a flowchart of a second exemplary qubit processing method, according to some embodiments of the present disclosure.

FIG. 4 is a flowchart of a third exemplary qubit processing method, according to some embodiments of the present disclosure.

FIG. 5 illustrates a schematic diagram of an exemplary qubit process 500, according to some embodiments of the present disclosure.

FIG. 6 is a schematic diagram of evolution of projection results at three angles over evolution durations of three second magnetic flux pulses, according to some embodiments of the present disclosure.

FIG. 7 is a schematic diagram illustrating a process of determining a target operating point, according to some embodiments of the present disclosure.

FIG. 8 is a schematic diagram of acquiring decoherence time by a fitted curve, according to some embodiments of the present disclosure.

FIG. 9 is a fitted curve diagram of frequency of a qubit changing over magnetic flux pulses, according to some embodiments of the present disclosure.

FIG. 10 is a schematic structural diagram of a first exemplary qubit processing apparatus, according to some embodiments of the present disclosure.

FIG. 11 is a schematic structural diagram of a second exemplary qubit processing apparatus, according to some embodiments of the present disclosure.

FIG. 12 is a schematic structural diagram of a third exemplary qubit processing apparatus, according to some embodiments of the present disclosure.

FIG. 13 is a schematic structural diagram of an exemplary computer terminal, according to some embodiments of the present disclosure.

### DETAILED DESCRIPTION

Reference can now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the disclosure. Instead, they are merely examples of apparatuses and methods consistent with aspects related to the disclosure as recited in the appended claims. Particular aspects of present disclosure are described in greater detail below. The terms and definitions provided herein control, if in conflict with terms and/or definitions incorporated by reference.

According to some embodiments of the present disclosure, a qubit processing method is provided. It is be noted that the steps shown in the flowchart of the accompanying drawings may be executed in a computer system such as a set of computer-executable instructions, and moreover, although a logical order is shown in the flowchart, in some cases, the steps shown or described may be performed in an order different from that shown or described herein.

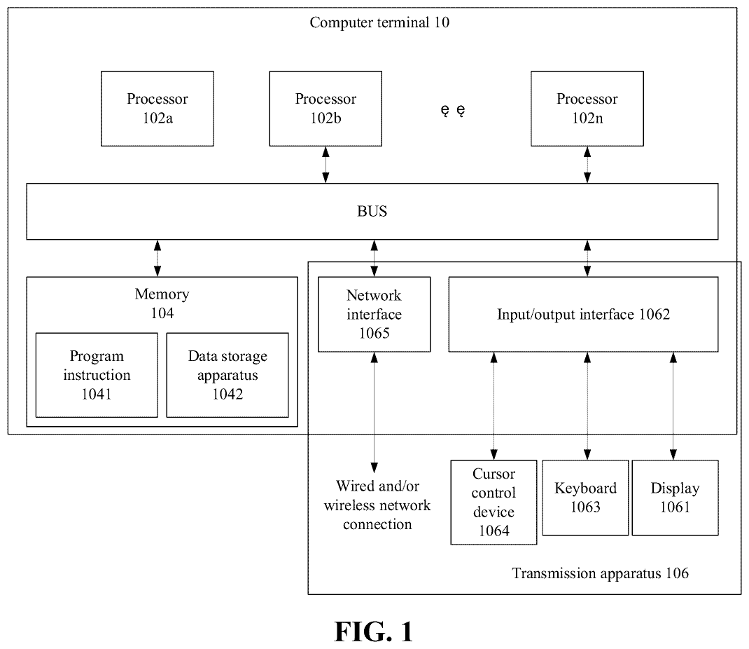

The methods provided according to the embodiments of the present disclosure may be executed in a mobile terminal, a computer terminal, or a similar arithmetic apparatus. FIG. 1 shows a hardware structure block diagram of an exemplary computer terminal (or mobile device) for implementing a qubit processing method, according to some embodiments of the present disclosure. As shown in FIG. 1, a computer terminal 10 (or mobile device) may include one or more processors (shown in the figure as 102a, 102b . . . 102n, and the processors may include but be not limited to processing apparatuses such as a microprocessor MCU or a programmable logic device FPGA), a memory 104 configured to store data, and a transmission apparatus 106 configured to perform a communication function. In addition, transmission apparatus 106 may further include a display 1061, an input/output interface (I/O interface) 1062, a keyboard 1063, a cursor control device 1064, a universal serial bus (USB) port (which may be included as one of the ports of a BUS), a network interface 1065, a power supply or a camera. It is appreciated that the structure shown in FIG. 1 is only a schematic diagram and does not cause limitation to the structure of the electronic apparatus. For example, computer terminal 10 may further include more or less components than those shown in FIG. 1, or has different configurations from those shown in FIG. 1.

It is be noted that the one or more processors or other data processing circuits may be generally called as a “data processing circuit” in the present disclosure. The data processing circuit may be completely or partially embodied as software, hardware, firmware or any other combination. In addition, the data processing circuit may be a single independent processing module or be completely or partially combined into any one of other elements in computer terminal 10 (or mobile device). As involved in the embodiments of the present disclosure, the data processing circuit serves as a processor control (such as selection of a variable resistance terminal path connected with the interface).

Memory 104 can be configured to store software programs of application software and modules, such as a program instruction 1041/data storage apparatus 1042 corresponding to the qubit processing method according to the embodiments of the present disclosure. The processor executes various function applications and data processing by running the software programs and the modules stored in memory 104, namely, a qubit processing method is realized. Memory 104 can include a high-speed random access memory and can also include a nonvolatile memory, such as one or more magnetic storage apparatuses, flash memories or other nonvolatile solid-state memories. In some examples, memory 104 can further include memories remotely arranged relative to the processor, and the remote memories may be connected to computer terminal 10 through a network. The examples of the network include but are not limited to the Internet, an intranet, a local area network, a mobile communication network and a combination thereof.

Transmission apparatus 106 is configured to receive or transmit data through a network. The specific examples of the network can include a wireless network provided by a communication provider of the computer terminal 10. In one example, the transmission apparatus includes a network interface controller (NIC), and the network interface controller can be connected with other network devices through a base station so as to communicate with the internet. In one example, the transmission apparatus may be a radio frequency (RF) module and is configured to communicate with the internet in a wireless mode.

Display 1601 may be, for example, a touch screen type liquid crystal display (LCD), and the LCD enables a user to interact with a user interface of computer terminal 10 (or mobile device).

It is to be noted that in some embodiments, computer device 10 (or mobile device) shown in FIG. 1 may include a hardware element (including a circuit), a software element (including computer codes stored on the computer readable medium) or a combination of the hardware element and the software element. It is to be pointed out that FIG. 1 is only one example of a specific example and aims at showing the type of components which can be in the computer device (or mobile device).

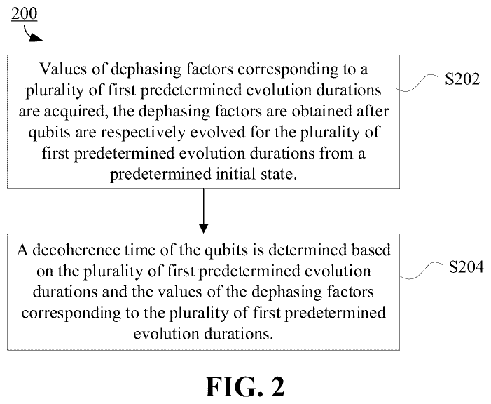

Under the above operating environment, the present disclosure provides a qubit processing method as shown in FIG. 2. FIG. 2 is a flowchart of a first exemplary qubit processing method 200, according to some embodiments of the present disclosure. As shown in FIG. 2, method 200 includes steps S202 and S204.

At step S202, values of dephasing factors corresponding to a plurality of first predetermined evolution durations are acquired, the dephasing factors are obtained after a qubit is respectively evolved for the plurality of first predetermined evolution durations from a predetermined initial state. Dephasing is a process in which the qubits lose quantum coherence. A speed of dephasing may be characterized by dephasing factors.

In some embodiments, an execution entity of the qubit processing method may be a terminal or a server. The terminal may be various types of terminals, such as a computer terminal, a mobile terminal, and a virtual terminal, but no matter which type of terminal, a certain computing capability meeting computing requirements needs to be achieved. The server may be in various forms, such as a single computer device, a computer cluster including a plurality of computers, a local computing unit, and a remote cloud server.

In some embodiments, the qubits may be of multiple types, for example, Fluxonium qubits, or Transmon qubits, charge qubits, phase qubits and other types of frequency-adjustable qubits, which are not limited in this embodiment of the present disclosure.

In some embodiments, the predetermined initial state may be obtained by applying a magnetic flux pulse to the qubits, and may be a random quantum state or a quantum state meeting a certain requirement. In quantum mechanics, the quantum coherence of an open quantum system will gradually lose over time due to quantum entanglement with the external environment, and this effect is called Quantum decoherence, also known as quantum decorrelation. Quantum decoherence is the consequence of quantum entanglement between a quantum system and its environment. The interference phenomenon due to quantum coherence will disappear due to quantum decoherence. Quantum decoherence makes the quantum behavior of the system change into classical behavior, which is called “quantum-to-classical transition”. The decoherence of the qubit refers to that the coherence of the qubits disappears over change of time under the influence of the external environment. Therefore, when describing the magnitude of the coherence of the qubits over change of time, a dephasing factor may be adopted for representation, that is, the dephasing factor and the coherence of the qubits is positively correlated. The dephasing factor is reduced along with the increase of time. When the dephasing factor is an initial value, the coherence of the qubits is the best; and when the dephasing factor is ideal zero, the qubits do not have decoherence.

It is to be noted that when the dephasing factor is obtained, it is necessary to measure the qubits. The measurement may certainly influence the qubits, and then the state of the qubits may be derived from the measurement result. The qubits may be measured based on a preset coordinate system. The measurement result obtained by measuring the qubits may be the state of the whole qubits obtained based on the component result obtained by projecting the qubits to a certain coordinate axis in the coordinate system.

In some embodiments, the evolution is a process that a quantum state is influenced by the environment. The size of the specified predetermined evolution duration may be flexibly determined based on requirements, for example, the size of the predetermined evolution duration may be several or dozens of microseconds and the like. The predetermined evolution duration may be a duration equivalent to the estimated decoherence time of the qubits, for example, when the estimated decoherence time of the qubit is dozens of microseconds, the size of the predetermined evolution duration may also be corresponding dozens of microseconds.

In some embodiments, acquiring the values of dephasing factors corresponding to a plurality of first predetermined evolution durations after qubits are respectively evolved for the plurality of first predetermined evolution durations from a predetermined initial state refers to that the qubits are evolved for a predetermined evolution duration from the predetermined initial state to obtain a value of a dephasing factor corresponding to the predetermined evolution duration, and a plurality of values corresponding to different dephasing factors can be obtained after the qubits are evolved for different predetermined evolution durations from the predetermined initial state.

In some embodiments, acquiring the values of dephasing factors corresponding to a plurality of first predetermined evolution durations after qubits are respectively evolved for the plurality of first predetermined evolution durations from a predetermined initial state may be implemented by the following mode: for any one of the plurality of first predetermined evolution durations, after the qubits are evolved for the any first predetermined evolution duration from the predetermined initial state, applying a plurality of first magnetic flux pulses to the qubits for projection measurement to obtain first measurement results corresponding to the plurality of first magnetic flux pulses; acquiring the value of the dephasing factor corresponding to the any first predetermined evolution duration based on the first measurement results corresponding to the plurality of first magnetic flux pulses; and acquiring the values of the dephasing factors corresponding to the plurality of first predetermined evolution durations by the mode of acquiring the value of the dephasing factor corresponding to any first predetermined evolution duration. A projection measurement is a process in which projecting the qubits into a specific direction for measurement.

In some embodiments, acquiring the value of the dephasing factor corresponding to the any first predetermined evolution duration based on the first measurement results corresponding to the plurality of first magnetic flux pulses may be implemented based on a relationship between the measurement result and the dephasing factor, for example, the value is determined through a function relationship between the measurement result and the dephasing factor. For example, the dephasing factor may be represented as a function taking the measurement results corresponding to the plurality of first magnetic flux pulses as variables (the function may be obtained based on certain theoretical derivation); and when the first measurement results corresponding to the plurality of first magnetic flux pulses are obtained, the obtained first measurement results corresponding to the plurality of first magnetic flux pulses may be substituted into the abovementioned function so as to obtain the value of the corresponding dephasing factor.

It is to be noted that the number of the plurality of first magnetic flux pulses is not limited, for example, there may be two or three first magnetic flux pulses. When there are three first magnetic flux pulses, the corresponding phases of the three first magnetic flux pulses in projection measurement are sequentially spaced by a predetermined phase value, for example, the predetermined phase value may be approximately 120 degrees. Therefore, the plurality of first magnetic flux pulses may be pulses having the same amplitude, and the corresponding phases of the three first magnetic flux pulses in projection measurement are different. It is to be pointed out that the magnetic flux pulses in the first magnetic flux pulses may be understood as a magnetic flux bias. In addition, when two magnetic flux pulses are adopted to obtain the dephasing factor corresponding to the corresponding predetermined evolution duration, because it is necessary to correspondingly limit the environment, some instability may exist. Therefore, to avoid the instability caused by the environment, the three magnetic flux pulses may be selected for projection measurement to determine the dephasing factor corresponding to the predetermined evolution duration.

In some embodiments, before acquiring the values of dephasing factors corresponding to a plurality of first predetermined evolution durations after qubits are respectively evolved for the plurality of first predetermined evolution durations from a predetermined initial state, the decoherence conditions of the qubits are different in different working states. To reflect the decoherence process more comprehensively and efficiently and obtain the whole decoherence process, the qubits may be selected to work at a target working point. Therefore, before the qubits are evolved for the evolution durations from the predetermined initial state, an ideal working state (i.e., a state corresponding to the target working point, the decoherence time of the qubits at the target working point is relatively long, and the controllable adjustment range is relatively large) of the qubits may be determined, then, the qubits are controlled to be at the target working point, and thus the qubits are evolved at the target working point.

In some embodiments, the target working point of the qubits may be determined by the following mode: determining a fixed evolution duration, and a second magnetic flux pulse; determining a plurality of third magnetic flux pulses including the second magnetic flux pulse within a predetermined range around the second magnetic flux pulse; after the qubits are evolved for the fixed evolution duration from the predetermined initial state, respectively applying the plurality of third magnetic flux pulses to the qubits for projection measurement so as to obtain candidate values of the dephasing factors corresponding to the plurality of three magnetic flux pulses; selecting the third magnetic flux pulse having the largest candidate value of the dephasing factor from the plurality of third magnetic flux pulses as a target magnetic flux pulse; and fixing the qubits under the target magnetic flux pulse, and respectively evolving the qubits for the plurality of first predetermined evolution durations from the predetermined initial state. Through this processing, under a fixed evolution duration, the second magnetic flux pulse is used as an initial magnetic flux pulse, and the magnetic flux pulse with the maximum value of the dephasing factor is found near the initial magnetic flux pulse to serve as the target working point of the qubits. It is to be noted that the process of determining the dephasing factor for one magnetic flux pulse is similar to the process described above with first magnetic flux pulse, that is, the dephasing factor corresponding to the magnetic flux pulse may be obtained by selecting a mode of performing three times of measurement (the phases in three times of projection measurement are different) with the magnetic flux pulse. Then, the qubits are controlled to evolve for the plurality of first predetermined evolution durations under the magnetic flux bias corresponding to the target working point.

Step S204, a decoherence time of the qubit is determined based on the plurality of first predetermined evolution durations and the values of the dephasing factors corresponding to the plurality of first predetermined evolution durations.

In some embodiments, determining a decoherence time of the qubit based on the plurality of first predetermined evolution durations and the values of the dephasing factors corresponding to the plurality of first predetermined evolution durations may be implemented by a plurality of modes. For example, a first relationship curve between the dephasing factors and the durations is acquired based on the plurality of first predetermined evolution durations and the values of the dephasing factors corresponding to the plurality of first predetermined evolution durations; then, a decoherence time of the qubit is determined based on the first relationship curve. It is to be noted in the step of acquiring a first relationship curve between the dephasing factors and the durations based on the plurality of first predetermined evolution durations and the values of the dephasing factors corresponding to the plurality of first predetermined evolution durations, the first relationship curve may be obtained in various modes, for example, a curve fitting mode, and an artificial intelligence (AI) automatic acquisition mode, which is not limited herein. When the curve fitting mode is adopted, a predetermined fitting function type may be adopted based on a certain number of existing data to obtain a relationship curve corresponding to this type. When the AI automatic acquisition mode is adopted, it may be the mode of training a machine model based on AI, and the trained model can input certain data and then output the evolution law of the data, thus acquiring the first relationship curve.

In some embodiments, in the curve fitting process, a simple fitting mode may be adopted, that is, fitting is carried out through discrete points by adopting a predetermined fitting function to obtain the fitting result. For example, acquiring a first relationship curve between the dephasing factors and the durations based on the plurality of first predetermined evolution durations and the values of the dephasing factors corresponding to the plurality of first predetermined evolution durations may be implemented by the following mode: determining the number of the plurality of first predetermined evolution durations, and a first fitting function; and acquiring the first relationship curve between the dephasing factors and the durations by using the first fitting function based on the number of first predetermined evolution durations and the values of the dephasing factors corresponding to the number of first predetermined evolution durations. Through the processing, a certain number of discrete first predetermined evolution durations, the values of the corresponding dephasing factors, and the first fitting function are adopted, and thus a relationship curve of the dephasing factors and the durations can be obtained. It is to be noted that the first fitting function may be determined based on the empirical characteristics of the decoherence time, for example, a function in an exponential form may be selected as the first fitting function, and the exponential function may be an exponential function in an exponential decreasing form.

In some embodiments, when determining a decoherence time of the qubits based on the first relationship curve, a target value reached by the dephasing factor is selected, and the duration corresponding to the target value is determined as the decoherence time of the qubits from the first relationship curve. For example, a target value of the dephasing factors is determined; and the duration corresponding to the target value is determined as the decoherence time of the qubits on the first relationship curve. The target value may be determined based on a certain standard, for example, the target value may be determined based on a fitting function corresponding to the first relationship curve. For example, under the general condition, when the value of the fitting function is a certain standard value, it is determined that the coherence is finished, that is, the qubits do not have the coherence. Therefore, the dephasing factor corresponding to the standard value is the target value. In the case that the exponential function in the exponential decreasing form, the target value may be obtained based on one eth (i.e., 1/e), for example, the decoherence of the qubits is that when the dephasing factor is one eth (i.e., 1/e) of the maximum value, the corresponding duration on the first relationship curve is the decoherence time of the qubits.

According to the steps above, the mode of evolving the qubits for the plurality of predetermined evolution durations to obtain the dephasing factors corresponding to the plurality of evolution durations, obtaining a fitted curve of the dephasing factors and the durations, and obtaining the decoherence time of the qubits based on the fitted curve is adopted. The decoherence time of the qubits is obtained through the fitted curve, thus the purpose of acquiring the decoherence time of the qubits through a small amount of measurement data is achieved, then the technical effect of quickly and efficiently acquiring the performances of the qubits is achieved, and as a result, the technical problem of low efficiency in measuring performances of the qubits in related technology is solved.

In some embodiments, as described above, different magnetic flux pulses may affect the decoherence time of the qubits. To obtain the influence of different magnetic flux pulses on the decoherence time, after determining a decoherence time of the qubits based on the plurality of first predetermined evolution durations and the values of the dephasing factors corresponding to the plurality of first predetermined evolution durations, the following steps are carried out: acquiring values of the decoherence time by evolving the qubits under a plurality of fourth magnetic flux pulses respectively by the mode of acquiring the decoherence time as described above; and acquiring a second relationship curve between the decoherence times and the magnetic flux pulses based on the values of the decoherence time corresponding to the plurality of fourth magnetic flux pulses. The fitting mode may refer to the mode of acquiring the first relationship curve between the dephasing factors and the durations.

In some embodiments, the performances of qubits may include decoherence time and the frequency spectrum formed based on adjustable frequency. To obtain the frequency spectrum of the qubits, a relationship curve between the frequencies of the qubits and the magnetic flux pulses may be obtained when needed. The frequency spectrum of qubit, that is, qubit spectrum, is a variation spectrum of frequency-tunable qubits as a function of externally modulating magnetic flux. For example, the following mode may be adopted: acquiring corresponding initial frequencies of the qubits under a plurality of fifth magnetic flux pulses; acquiring phase change rates of the qubits when applying the plurality of fifth magnetic flux pulses respectively; acquiring frequency values corresponding to the plurality of fifth magnetic flux pulses based on the corresponding initial frequencies under the plurality of fifth magnetic flux pulses and the phase change rates corresponding to the plurality of fifth magnetic flux pulses, respectively; and acquiring a third relationship curve between the frequencies of the qubits and the magnetic flux pulses based on the plurality of fifth magnetic flux pulses and the frequency values corresponding to the plurality of fifth magnetic flux pulses. Through the processing, the frequency values corresponding to the plurality of fifth magnetic flux pulses respectively and the plurality of fifth magnetic flux pulses are obtained, and then the relationship curve between the frequencies of the qubits and the magnetic flux pulses is obtained, so that the frequency spectrum of the qubits is obtained. That is, the frequency spectrum of the qubits is obtained by simply measuring the qubits and fitting based on the measurement result. Compared with a mode of acquiring the frequency spectrum of the qubits in related technology, this mode is faster and simpler, and the time for testing the performance of the qubits is effectively decreased.

In some embodiments, acquiring phase change rates of the qubits when applying the plurality of fifth magnetic flux pulses respectively includes: for any one of the plurality of fifth magnetic flux pulses, acquiring phase values of the qubits after evolving for a plurality of second predetermined evolution durations under the any fifth magnetic flux pulse; determining the phase change rate of the qubits under the any fifth magnetic flux pulse based on the plurality of second predetermined evolution durations and the phase values corresponding to the plurality of second predetermined evolution durations; and acquiring the phase change rates of the qubits when applying the plurality of fifth magnetic flux pulses by the mode of acquiring the phase change rate of the any fifth magnetic flux pulse. By the above processing mode, for any fifth magnetic flux pulse, the corresponding phase change rate is determined based on the second predetermined evolution durations and the phase values corresponding to the second predetermined evolution durations. A simple processing mode is to determine the change of the phase values under the change durations corresponding to the evolution durations, that is, a ratio of the phase difference value to the evolution duration difference value, which is the phase change rate corresponding to the any fifth magnetic flux pulse.

It is to be noted that acquiring phase values of the qubits after evolving for a plurality of second predetermined evolution durations under any fifth magnetic flux pulse may be implemented by the abovementioned mode of acquiring the dephasing factor, or acquiring the phase value of the qubits under certain fifth magnetic flux pulse through the same measurement process while acquiring the dephasing factor of the qubits under the fifth magnetic flux pulse. For example, the following mode may be adopted: acquiring phase values of the qubits after evolving for a plurality of second predetermined evolution durations under any fifth magnetic flux pulse; for any one of the plurality of second predetermined evolution durations, determining a sixth magnetic flux pulse corresponding to the any fifth magnetic flux pulse, the sixth magnetic flux pulse having an amplitude the same as that of the any fifth magnetic flux pulse, but having a different corresponding phase for projection measurement; after the evolution of the qubits for any second predetermined evolution duration from the predetermined initial state, respectively applying the any fifth magnetic flux pulse and the sixth magnetic flux pulse to the qubits for projection measurement so as to obtain a second measurement result of the any fifth magnetic flux pulse and a third measurement result corresponding to the sixth magnetic flux pulse; acquiring the phase value corresponding to the any second predetermined evolution duration based on the second measurement result of the any fifth magnetic flux pulse and the third measurement result corresponding to the sixth magnetic flux pulse; and acquiring the phase value of the qubits after evolving for the plurality of second predetermined evolution durations under the any fifth magnetic flux pulse respectively by the mode of acquiring the phase value corresponding to the any second predetermined evolution duration. The difference between this mode and acquiring the dephasing factor of the qubits lies merely in different target parameters to be acquired, that is, one is to acquire the dephasing factor, and the other is to acquire the phase value. When acquiring the dephasing factor and acquiring the phase value are implemented through the same measurement process, the any fifth magnetic flux pulse and the sixth magnetic flux pulse correspond to the plurality of first magnetic flux pulses.

In some embodiments, determining the phase change rate of the qubits under the any fifth magnetic flux pulse based on the plurality of second predetermined evolution durations and the phase values corresponding to the plurality of second predetermined evolution durations may be implemented through the following mode: selecting two target second predetermined evolution durations from the plurality of second predetermined evolution durations, and determining a duration difference between the two target second predetermined evolution durations; determining a phase difference between the corresponding phase values of the two target second predetermined evolution durations; and determining the phase change rate of the qubits under the any fifth magnetic flux pulse based on the phase difference and the duration difference. Specifically, when determining the phase change rate of the qubits under any fifth magnetic flux pulse based on the phase difference value and the duration difference value, the ratio of the phase difference value to the duration difference value may be determined as the phase change rate. In some embodiments, the phase change rate may be obtained by linearly fitting a set of measurement phases and evolution durations corresponding to the measurement phases, and the slope of a linear function obtained by fitting corresponds to the phase change rate.

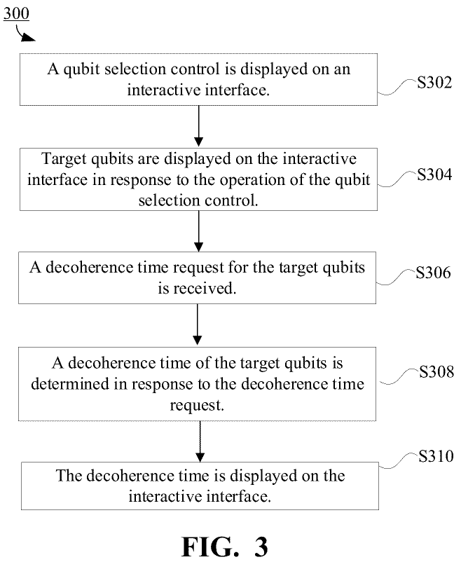

FIG. 3 is a flowchart of another qubit processing method 300 according to some embodiments of the present disclosure. As shown in FIG. 3, method 300 includes steps S302 to S310.

At step S302, a qubit selection control is displayed on an interactive interface.

At step S304, a target qubit is displayed on the interactive interface in response to the operation of the qubit selection control.

At step S306, a decoherence time request for the target qubit is received.

At step S308, a decoherence time of the target qubit is determined in response to the decoherence time request. The decoherence time is obtained based on a plurality of first predetermined evolution durations and the values of dephasing factors corresponding to the plurality of first predetermined evolution durations. The values of the dephasing factors corresponding to the plurality of first predetermined evolution durations are obtained after evolving the target qubits for the plurality of first predetermined evolution durations from a predetermined initial state.

At step S310, the decoherence time is displayed on the interactive interface.

According to the above steps, based on the interactive operation on the interactive interface, the qubit is evolved for the plurality of predetermined evolution durations to obtain the dephasing factors corresponding to the plurality of evolution durations, the decoherence time of the qubit is obtained based on the plurality of evolution durations and the dephasing factors corresponding to the plurality of evolution durations, and the decoherence time is displayed on the interactive interface, so that the purpose of acquiring the decoherence time of the qubits through a small amount of measurement data is achieved, and the technical effect of quickly and efficiently acquiring the performances of the qubits is achieved; moreover, the decoherence time is displayed in an explicit and intuitive way, thus the technical problem of Low efficiency in measuring performances of the qubits in related technology is solved.

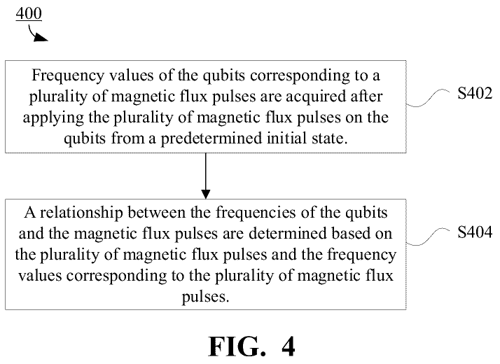

FIG. 4 is a flowchart of an exemplary qubit processing method 400 according to some embodiments of the present disclosure. As shown in FIG. 4, method 400 includes steps S402 and S404.

At step S402, frequency values of a qubit corresponding to a plurality of magnetic flux pulses are acquired after applying the plurality of magnetic flux pulses on the qubit from a predetermined initial state.

At step S404, a relationship between the frequencies of the qubit and the magnetic flux pulses is determined based on the plurality of magnetic flux pulses and the frequency values corresponding to the plurality of magnetic flux pulses.

According to the steps above, the frequency values of the qubits is obtained after applying a plurality of magnetic flux pulses on the qubit from the predetermined initial state and corresponding to the plurality of magnetic flux pulses, and the relationship between the frequencies of the qubits and the magnetic flux pulses, that is, the frequency spectrum of the qubits, is obtained based on the frequency values corresponding to the plurality of magnetic flux pulses, thus the purpose of acquiring the frequency spectrum of the quantum bit through a small amount of measurement data is achieved, and the technical effect of quickly and efficiently acquiring the performance parameters of the qubits (the frequency spectrum of the qubits) is achieved, and as a result, the technical problem of low efficiency in measuring performances of the qubits in related technology is solved.

It is to be noted that the mode of directly determining the frequency spectrum of the qubits based on measurement data may be the same as the measurement process adopted when the decoherence time is determined, and the obtained measurement data may also be similar, so that the process of acquiring the decoherence time and the frequency spectrum of the qubits based on the measurement data may also be similar, and the difference is only that the parameter types to be determined are different, one is the decoherence time, and the other is the spectrum. Therefore, the scheme of independently acquiring the frequency spectrum of the quantum bit may be similar to the scheme of acquiring the spectrum adopted when the decoherence time and the spectrum are obtained in a combined mode, or may be flexibly changed. Therefore, for the specific process of positive acquisition, the related similar processing is not described in detail one by one.

In some embodiments, acquiring frequency values of the qubit corresponding to a plurality of magnetic flux pulses after applying the plurality of magnetic flux pulses from a predetermined initial state includes: for any one of the plurality of magnetic flux pulses, acquiring an initial frequency of the qubit under the any magnetic flux pulse; acquiring the phase change rate of the qubits when applying the any magnetic flux pulse; acquiring the frequency value corresponding to the any magnetic flux pulse based on the initial frequency and the phase change rate; and acquiring the frequency values of the qubits corresponding to the plurality of magnetic flux pulses after applying the plurality of magnetic flux pulses by a mode of acquiring the frequency value corresponding to the any magnetic flux pulses.

In some embodiments, acquiring the phase change rate of the qubits when applying the any magnetic flux pulse includes: acquiring the phase value of the qubits after evolving for the plurality of predetermined evolution durations under the any magnetic flux pulse; and determining the phase change rate of the qubits when applying the any magnetic flux pulse based on the plurality of predetermined evolution durations, and the phase values corresponding to the plurality of predetermined evolution durations.

In some embodiments, acquiring the phase value of the qubits after evolving for the plurality of predetermined evolution durations under the any magnetic flux pulse includes: for any one of the plurality of predetermined evolution durations, determining other magnetic flux pulses corresponding to the any magnetic flux pulse, the other magnetic flux pulses having the same amplitude as the any magnetic flux pulse, and the phases for projection measurement being different; after evolution of the qubits for the any predetermined evolution duration from the predetermined initial state, respectively applying the any magnetic flux pulse and the other magnetic flux pulses to the qubits for projection measurement to obtain a measurement result of the any magnetic flux pulse and measurement results corresponding to the other magnetic flux pulses; acquiring the phase value corresponding to the any predetermined evolution duration based on the measurement result of the any magnetic flux pulse and the measurement results corresponding to the other magnetic flux pulses; and acquiring the phase value of the qubits after evolving for the plurality of preset evolution durations under the any magnetic flux pulse by the mode of acquiring the phase value corresponding to the any predetermined evolution duration.

In some embodiments, determining the phase change rate of the qubits when applying the any magnetic flux pulse based on the plurality of predetermined evolution durations, and the phase values corresponding to the plurality of predetermined evolution durations includes: selecting two target predetermined evolution durations from the plurality of predetermined evolution durations, and determining a duration difference value between the two target predetermined evolution durations; determining a phase difference value between phase values corresponding to the two target predetermined evolution durations respectively; and based on the phase difference value and the duration difference value, determining the phase change rate of the qubits under any magnetic flux pulse.

Based on the foregoing embodiments, an optional implementation manner is provided.

The method provided by the embodiments of the present disclosure is wide in application and can be applied to research on causing decoherence related noise on Fluxonium qubits. The frequency spectrum of the Fluxonium qubits is calibrated, and it is also used for feedback for micro-nano processing parameter calibration. Fluxonium is a type of superconducting qubit, which is composed of a Josephson junction in parallel with an inductor and capacitor. In this composition, there is a large inductor (generally prepared from a large number of Josephson junctions (e.g., 100) arrays or high dynamic inductance materials). The electric energy EC corresponding to the capacitance, the inductive energy EL corresponding to the inductor, and the Josephson energy EJ are close to each other (about an order of magnitude).

According to the embodiments of the present disclosure, projection measurement (for example, three times spaced by approximately 120 degrees in phase) may be carried out on the qubits for multiple times, and decoherence information of the initial bits and the accumulated dynamic phase can be quickly estimated through the minimum data points as much as possible. According to the scheme, the experiment time for researching the change of the phase reduction over the external magnetic flux may be greatly shortened (more than half of time consumption can be reduced as compared to a previous method), and meanwhile, the change of the bit frequency over the external magnetic flux may be quickly calibrated.

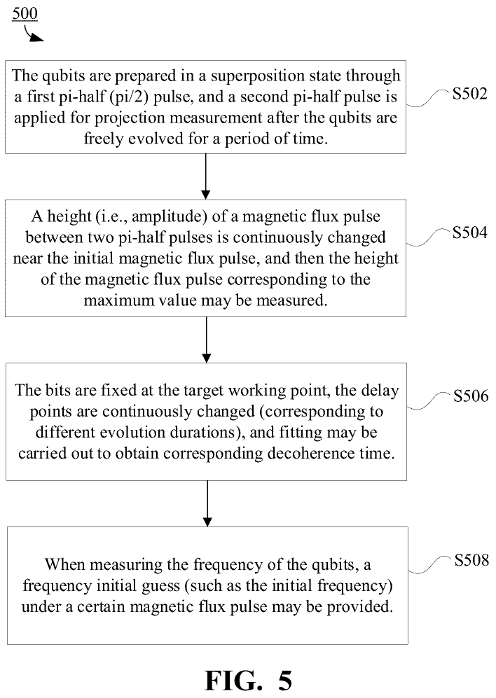

This implementation manner will be described below. FIG. 5 illustrates a schematic diagram of an exemplary qubit process 500, according to some embodiments of the present disclosure. As shown in FIG. 5, qubit process 500 includes steps S502 to S508.

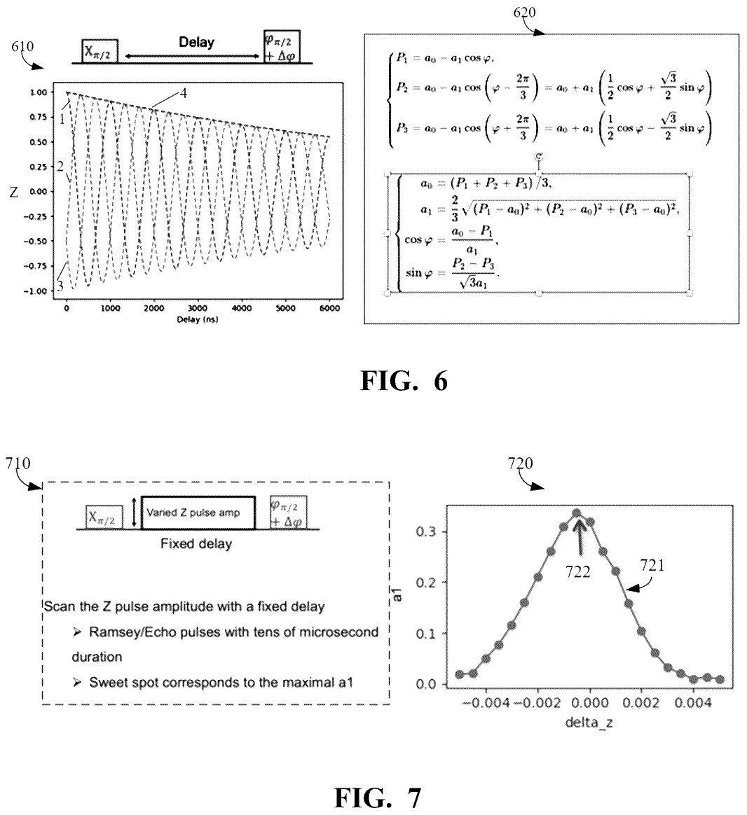

At step S502, a qubit is prepared in a superposition state through a first pi-half (pi/2) pulse, and a second pi-half pulse is applied for projection measurement after the qubits are freely evolved for a period of time. This projection measurement needs to be carried out for three times, and the phase of the second pulse is sequentially spaced by approximately 120 degrees in the three times of measurement. FIG. 6 is a schematic diagram of evolution of three projection measurement results over evolution durations of second magnetic flux pulses, according to some embodiment of the present disclosures. As shown in FIG. 6, a diagram 610 illustrates a relationship between projections on z-axis and delays. As shown in diagram 610, the phases (1, 2, 3) in the three projection measurements are respectively spaced by 120 degrees, and after the evolution of the evolution duration, the projection measurement on a Z axis can be seen from the curve 4 in diagram 610. A block 620 illustrates a derivation process of the phase factor and the phase information. In block 620, P1, P2 and P2 are the probabilities of three times of measurement respectively.

A factor a₁ corresponding to the dephasing and φ(\varphi.) of the corresponding phase information (e.g., sin φ and cos φ shown in block 620 of FIG. 6) may be extracted from the three measurement results. By using the information, the decoherence time and frequency spectrum of the qubit may be quickly measured, and the two pieces of information may be combined together for researching a decoherence mechanism.

At step S504, a time delay is fixed of about 10 μs-20 μs, a height (i.e., amplitude) of a magnetic flux pulse between two pi-half pulses is continuously changed near the initial magnetic flux pulse (the initial magnetic flux pulse may be a magnetic flux pulse relatively related to the magnetic flux pulse corresponding to the target working point, and the initial magnetic flux pulse may be obtained based on experience or a certain preliminary calculation), and then the height 1 of the magnetic flux pulse corresponding to the maximum value may be measured. This amplitude value corresponds to the target working point of the bit. FIG. 7 is a schematic diagram for determining a target working point, according to some embodiments of the present disclosure. Referring to FIG. 7, a target work point can be determined according to a process shown in block 710. A Z plus amplitude (e.g., the Z axis shown in FIG. 6) is scanned with a fixe delay. Then, Ramsey/Echo pluses are evolved for tens of microsecond duration. A sweet spot corresponding to the maximal a₁ is determined as the work point. Ramsey interference experiment refers to applying two π/2 quantum logic gate operations to a qubit, the time interval between the two operations is t, and at the same time applying a readout pulse to the qubit after the second π/2 quantum logic gate operation to obtain the excited state distribution P1(τ) of the qubit, and changing the time interval τ to obtain P1(τ). Referring to diagram 720 showing a relationship between magnetic flux and dephasing factors, when an initial magnetic flux (which may be an abscissa corresponding to any point on the curve 721) is given, dephasing factors (i.e., a₁ in the vertical axis) corresponding to the magnetic flux pulses corresponding to the point and the points near the point are respectively determined. It can be seen from diagram 710 that the point identified by an arrow 722 is the position where the dephasing factor a₁ is maximum, that is, the abscissa corresponding to the point is the magnetic flux pulse corresponding to the target working point of the qubits.

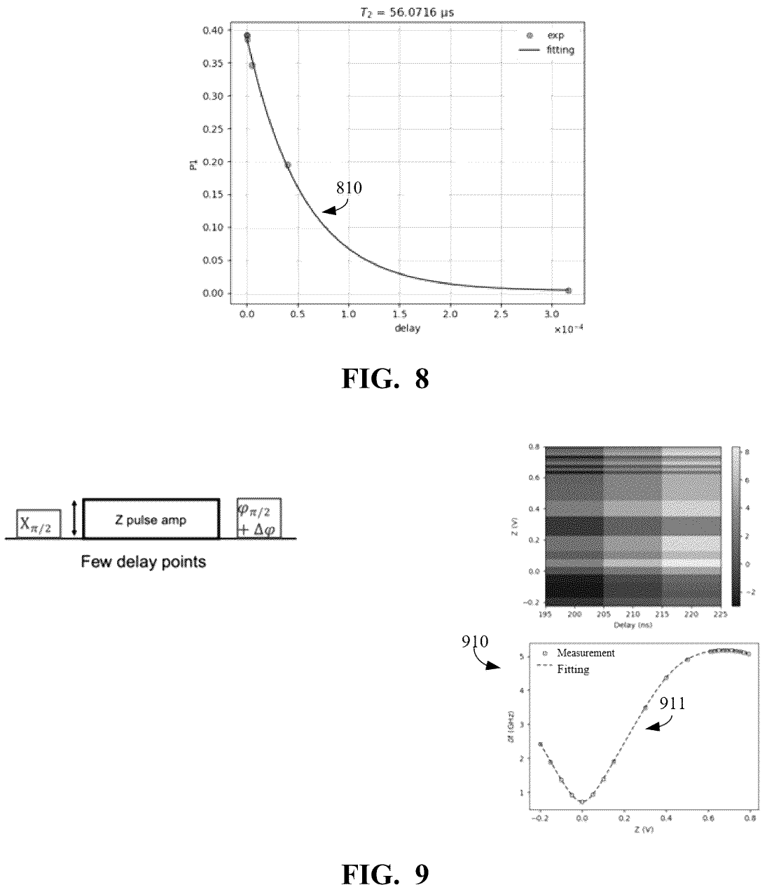

Referring back to FIG. 5, at step S506, the bit is fixed at the target working point, the delay points are continuously changed (corresponding to different evolution durations), and fitting may be carried out to obtain corresponding decoherence time. FIG. 8 is a schematic diagram of decoherence time obtained by a fitted curve, according to some embodiments of the present disclosure. As shown in FIG. 8, in the fitting process, that is, when the plurality of evolution durations and the decoherence time (as shown in discrete points in FIG. 8) corresponding to the plurality of evolution durations are adopted, the relationship (i.e., a curve 810) of the dephasing factor changing over time is obtained by fitting based on a predetermined fitting function (taking a function in the exponential form in FIG. 8 as an example). Then, a target phase-withdrawing factor meeting the decoherence ending is determined, and the duration corresponding to the target dephasing factor is determined to be the decoherence time of the qubits.

In addition, to obtain the rule that qubits change over magnetic flux, the process of acquiring decoherence time may be repeated. By changing the magnetic flux pulse height in the process, data related to the decoherence time changing over the magnetic flux may be obtained.

Referring back to FIG. 5, at step S508, when measuring the frequency of the qubits, a frequency initial guess (such as the initial frequency) under a certain magnetic flux pulse may be provided. Then, the change slope (such as the abovementioned phase change rate) of the bit phase information is measured by the abovementioned mode, and the sum of the slope and the initial guess is the actual frequency of the bit. FIG. 9 illustrates a fitted curve diagram 910 of frequency of qubits changing over magnetic flux pulses, according to some embodiments of the present disclosure. As shown in FIG. 9, the discrete points in diagram 910 are measured values, the curve 911 is obtained by fitting, and the curve 911 obtained by fitting is the frequency spectrum of the qubits.

It is to be noted that similar functions may be achieved by projection measurement for two or more times according to some embodiments of the present disclosure, but projection measurement for three times is a good scheme considering stability and measurement speed.

According to the embodiments of the present disclosure, three-angle projection measurement is carried out for dynamic evolution measurement of the bits under the decoherence mechanism. The decoherence and spectrum information may be quickly extracted, and it is found in actual measurement that this method has very high robustness. Moreover, in the process of calibrating the decoherence time and the frequency, the required data points are remarkably less than those of a traditional method, and because the phase and decoherence information is determined through continuous three points, the measurement result is not prone to being affected by the external environment.

It is to be noted that for the foregoing method embodiments, for the sake of simple description, they are expressed as a series of action combinations, but it is appreciated that the present disclosure is not limited by the described action sequence. According to the present disclosure, certain steps may be performed in other orders or simultaneously. Secondly, it is appreciated that the embodiments described in the specification belong to preferred embodiments, and the actions and modules involved are not necessarily required by the present disclosure.

Through the description of the above embodiments, is it appreciated that the method according to the above embodiments can be realized by means of software and a necessary universal hardware platform, and the method can also be realized through hardware, but the former is a preferred embodiment in many cases. Based on this understanding, the technical solution of the prevent disclosure can be embodied in the form of a software product in essence or a part contributing to the prior art. The computer software product is stored in a computer readable storage medium (such as an ROM/RAM, a magnetic disk and an optical disk), and includes a plurality of instructions for enabling a terminal device (which can be a mobile phone, a computer, a server or network equipment and the like) to execute the methods of the embodiments of the present disclosure.

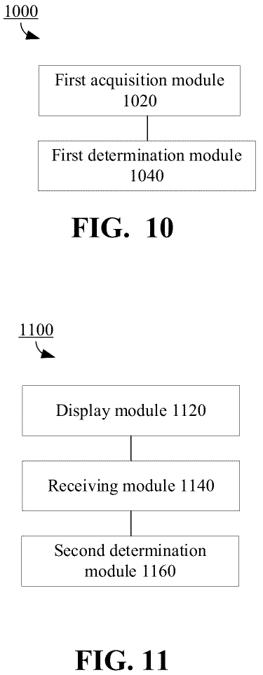

According to some embodiment of the present disclosure, an apparatus for implementing the abovementioned qubit processing method 200 is also provided. FIG. 10 is a structural block diagram of a qubit processing apparatus 1000, according to some embodiments of the present disclosure. As shown in FIG. 10, apparatus 1000 includes: a first acquisition module 1020 and a first determination module 1040, and the apparatus will be described below.

First acquisition module 1020 is configured to acquire values of dephasing factors corresponding to a plurality of first predetermined evolution durations after qubits are respectively evolved for the plurality of first predetermined evolution durations from a predetermined initial state. First determination module 1040 is coupled to first acquisition module 1020 and is configured to determine a decoherence time of the qubits based on the plurality of first predetermined evolution durations and the values of the dephasing factors corresponding to the plurality of first predetermined evolution durations.

It is to be noted that first acquisition module 1020 and first determination module 1040 correspond to steps S202 and S204 in method 200 as shown in FIG. 2, respectively. The two modules are the same as examples and application scenes realized by the corresponding steps, but are not limited to the content disclosed by method 200. It is to be noted that the modules (e.g., modules 1020 and 1040) as part of apparatus 1000 can run in a computer terminal 10 shown in FIG. 1.

According to some embodiments of the present disclosure, an apparatus for implementing the qubit processing method 300 is further provided. FIG. 11 is a schematic structural diagram of a qubit processing apparatus 1100, according to some embodiments of the present disclosure. As shown in FIG. 11, apparatus 1100 includes: a display module 1120, a receiving module 1140, and a second determination module 1160, and apparatus 1100 will be described below.

Display module 1102 is configured to display a qubit selection control on an interactive interface; and display target qubits on the interactive interface in response to the operation of the qubit selection control. Receiving module 1140 is coupled to display module 1140 and is configured to receive a decoherence time request for the target qubits. Second determination module 1160 is coupled to receiving module 1140 and is configured to determine a decoherence time of the target qubits in response to the decoherence time request, the decoherence time being obtained based on a plurality of first predetermined evolution durations, and the values of dephasing factors corresponding to the plurality of first predetermined evolution durations, and the values of the dephasing factors corresponding to the plurality of first predetermined evolution durations being obtained after evolving the target qubits for the plurality of first predetermined evolution durations from a predetermined initial state. Display module 1120 is further configured to display the decoherence time on the interactive interface.

It is to be noted that display module 1120, receiving module 1140 and second determination module 1160 correspond to steps S302-S306 in method 300 as shown in FIG. 3, respectively. The modules are the same as examples and application scenes realized by the corresponding steps, but are not limited to the content disclosed by method 300. It is to be noted that the modules (e.g., 1120, 1140, and 1160) as part of apparatus 1110 can run in a computer terminal 10 shown in FIG. 1.

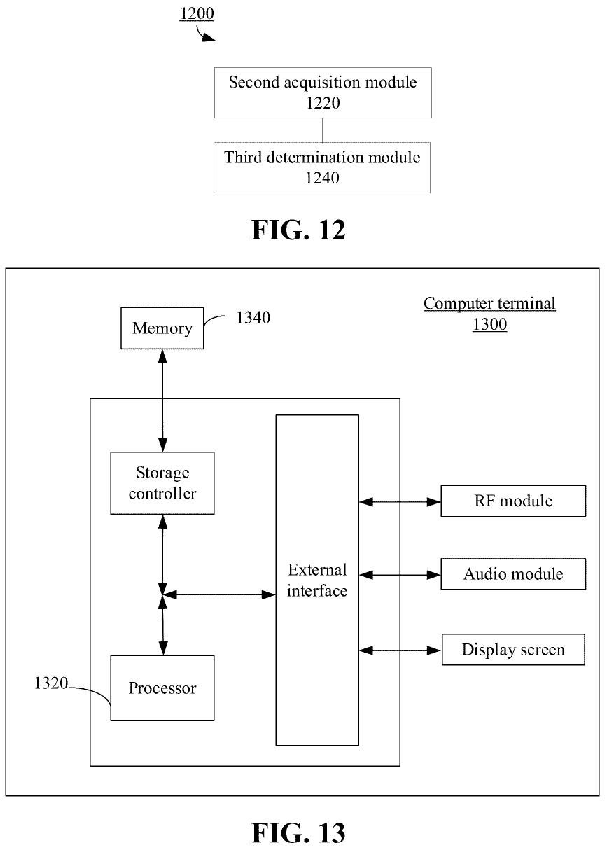

According to some embodiments of the present disclosure, an apparatus for implementing the qubit processing method 400 is further provided. FIG. 12 is a schematic structural diagram of a qubit processing apparatus 1200, according to some embodiments of the present disclosure. As shown in FIG. 12, apparatus 1200 includes: a second acquisition module 1220 and a third determination module 1240, and apparatus 1200 will be described below.

Second acquisition module 1220 is configured to acquire frequency values of the qubits corresponding to a plurality of magnetic flux pulses after applying the plurality of magnetic flux pulses from a predetermined initial state. Third determination module 1240 is coupled to second acquisition module 1220 and is configured to determine a relationship between the frequencies of the qubits and the magnetic flux pulses based on the plurality of magnetic flux pulses and the frequency values corresponding to the plurality of magnetic flux pulses.

It is to be noted that second acquisition module 1220 and third determination module 1240 correspond to steps S402-S404 in method 400 as shown in FIG. 4, respectively. The modules are the same as examples and application scenes realized by the corresponding steps, but are not limited to the content disclosed by method 400. It is to be noted that the modules (e.g., 1220 and 1240) as part of apparatus 1200 can run in a computer terminal 10 shown in FIG. 1.

Some embodiments of the present disclosure may provide a computer terminal which may be any computer terminal device in a computer terminal group. In some embodiments, the foregoing computer terminal may also be replaced with a terminal apparatus such as a mobile terminal.

In some embodiments, the foregoing computer terminal may be located in at least one of a plurality of network devices of the computer network.

In this embodiment, the computer terminal may execute the program code in the following steps of the qubit processing method for the application program: acquiring values of dephasing factors corresponding to a plurality of first predetermined evolution durations after qubits are respectively evolved for the plurality of first predetermined evolution durations from a predetermined initial state; acquiring a first relationship curve between the dephasing factors and the durations based on the plurality of first predetermined evolution durations and the values of the dephasing factors corresponding to the plurality of first predetermined evolution durations; and determining a decoherence time of the qubits based on the first relationship curve.

In some embodiments, FIG. 13 is a schematic structural diagram of a computer terminal 1300, according to some embodiments of the present disclosure. As shown in FIG. 13, computer terminal 1300 may include: one or more (only one shown in FIG. 13) processors 1320, a memory 1340, etc.

Memory 1340 can be configured to store software programs of application software and modules, such as a program instruction/data storage apparatus corresponding to the qubit processing method according to the embodiment of the present disclosure; and the processor executes various function applications and data processing by running the software programs and the modules stored in the memory, namely, a vulnerability detection method for the application programs is realized. The memory can include a high-speed random access memory and can also include a nonvolatile memory, such as one or more magnetic storage apparatuses, flash memories or other nonvolatile solid-state memories. In some examples, the memory can further include memories remotely arranged relative to the processor, and the remote memories may be connected to the computer terminal through a network. The examples of the network include but are not limited to the Internet, an intranet, a local area network, a mobile communication network and a combination thereof.

Processor 1320 may call the information and application program stored in memory 1340 through a transmission apparatus to execute the following steps: acquiring values of dephasing factors corresponding to a plurality of first predetermined evolution durations after qubits are respectively evolved for the plurality of first predetermined evolution durations from a predetermined initial state; and determining a decoherence time of the qubits based on the plurality of first predetermined evolution durations and the values of the dephasing factors corresponding to the plurality of first predetermined evolution durations.

In some embodiments, processor 1320 may also execute the program code of the following steps: acquiring the values of dephasing factors corresponding to a plurality of first predetermined evolution durations after qubits are respectively evolved for the plurality of first predetermined evolution durations from a predetermined initial state includes: for any one of the plurality of first predetermined evolution durations, after the qubits are evolved for the any first predetermined evolution duration from the predetermined initial state, applying a plurality of first magnetic flux pulses to the qubits for projection measurement to obtain first measurement results corresponding to the plurality of first magnetic flux pulses; acquiring the value of the dephasing factor corresponding to the any first predetermined evolution duration based on the first measurement results corresponding to the plurality of first magnetic flux pulses; and acquiring the values of the dephasing factors corresponding to the plurality of first predetermined evolution durations by a mode of acquiring the value of the dephasing factor corresponding to the any first predetermined evolution duration.

In some embodiments, processor 1320 may also execute the program code of the following steps: the plurality of first magnetic flux pulses include three first magnetic flux pluses; and the corresponding phases of the three first magnetic flux pulses in projection measurement are sequentially spaced by approximately 120 degrees.

In some embodiments, processor 1320 may also execute the program code of the following steps: before acquiring the values of dephasing factors corresponding to a plurality of first predetermined evolution durations after qubits are respectively evolved for the plurality of first predetermined evolution durations from a predetermined initial state, the method includes: determining a fixed evolution duration, and a second magnetic flux pulse; determining a plurality of third magnetic flux pulses comprising the second magnetic flux pulse within a predetermined range around the second magnetic flux pulse; after the qubits are evolved for the fixed evolution duration from the predetermined initial state, respectively applying the plurality of third magnetic flux pulses to the qubits for projection measurement so as to obtain candidate values of the dephasing factors corresponding to the plurality of three magnetic flux pulses; selecting the third magnetic flux pulse having the largest candidate value of the dephasing factor from the plurality of third magnetic flux pulses as a target magnetic flux pulse; and fixing the qubits under the target magnetic flux pulse, and respectively evolving the qubits for the plurality of first predetermined evolution durations from the predetermined initial state.

In some embodiments, processor 1320 may also execute the program code of the following steps: determining a decoherence time of the qubits based on the plurality of first predetermined evolution durations and the values of the dephasing factors corresponding to the plurality of first predetermined evolution durations includes: acquiring a first relationship curve between the dephasing factors and the durations based on the plurality of first predetermined evolution durations and the values of the dephasing factors corresponding to the plurality of first predetermined evolution durations; and determining a decoherence time of the qubits based on the first relationship curve.

In some embodiments, processor 1320 may also execute the program code of the following steps: acquiring a first relationship curve between the dephasing factors and the durations based on the plurality of first predetermined evolution durations and the values of the dephasing factors corresponding to the plurality of first predetermined evolution durations includes: determining the number of the plurality of first predetermined evolution durations, and a first fitting function; and acquiring the first relationship curve between the dephasing factors and the durations by using the first fitting function based on the number of first predetermined evolution durations and the values of the dephasing factors corresponding to the number of first predetermined evolution durations.

In some embodiments, processor 1320 may also execute the program code of the following steps: determining a decoherence time of the qubits based on the first relationship curve includes: determining a target value of the dephasing factors; and determining the duration corresponding to the target value as the decoherence time of the qubits on the first relationship curve.

In some embodiments, processor 1320 may also execute the program code of the following steps: after determining a decoherence time of the qubits based on the plurality of first predetermined evolution durations and the values of the dephasing factors corresponding to the plurality of first predetermined evolution durations, the method further includes: acquiring values of the decoherence time by evolving the qubits under a plurality of fourth magnetic flux pulses respectively; and acquiring a second relationship curve between the decoherence time and the magnetic flux pulses based on the values of the decoherence time corresponding to the plurality of fourth magnetic flux pulses.

In some embodiments, processor 1320 may also execute the program code of the following steps: acquiring corresponding initial frequencies of the qubits under a plurality of fifth magnetic flux pulses; acquiring phase change rates of the qubits when applying the plurality of fifth magnetic flux pulses respectively; acquiring frequency values corresponding to the plurality of fifth magnetic flux pulses based on the corresponding initial frequencies under the plurality of fifth magnetic flux pulses and the phase change rates corresponding to the plurality of fifth magnetic flux pulses, respectively; and acquiring a third relationship curve between the frequencies of the qubits and the magnetic flux pulses based on the plurality of fifth magnetic flux pulses and the frequency values corresponding to the plurality of fifth magnetic flux pulses.

In some embodiments, processor 1320 may also execute the program code of the following steps: acquiring phase change rates of the qubits when applying the plurality of fifth magnetic flux pulses respectively includes: for any one of the plurality of fifth magnetic flux pulses, acquiring phase values of the qubits after evolving for a plurality of second predetermined evolution durations under the any fifth magnetic flux pulse; determining the phase change rate of the qubits under the any fifth magnetic flux pulse based on the plurality of second predetermined evolution durations and the phase values corresponding to the plurality of second predetermined evolution durations; and acquiring the phase change rates of the qubits when applying the plurality of fifth magnetic flux pulses by the mode of acquiring the phase change rate of the any fifth magnetic flux pulse.

In some embodiments, processor 1320 may also execute the program code of the following steps: acquiring phase values of the qubits after evolving for a plurality of second predetermined evolution durations under any fifth magnetic flux pulse includes: for any one of the plurality of second predetermined evolution durations, determining a sixth magnetic flux pulse corresponding to the any fifth magnetic flux pulse, the sixth magnetic flux pulse having an amplitude the same as that of the any fifth magnetic flux pulse, but having a different corresponding phase for projection measurement; after the evolution of the qubits for any second predetermined evolution duration from the predetermined initial state, respectively applying the any fifth magnetic flux pulse and the sixth magnetic flux pulse to the qubits for projection measurement so as to obtain a second measurement result of the any fifth magnetic flux pulse and a third measurement result corresponding to the sixth magnetic flux pulse; acquiring the phase value corresponding to the any second predetermined evolution duration based on the second measurement result of the any fifth magnetic flux pulse and the third measurement result corresponding to the sixth magnetic flux pulse; and acquiring the phase value of the qubits after evolving for the plurality of second predetermined evolution durations under the any fifth magnetic flux pulse respectively by the mode of acquiring the phase value corresponding to the any second predetermined evolution duration.

In some embodiments, processor 1320 may also execute the program code of the following steps: determining the phase change rate of the qubits under the any fifth magnetic flux pulse based on the plurality of second predetermined evolution durations and the phase values corresponding to the plurality of second predetermined evolution durations includes: selecting two target second predetermined evolution durations from the plurality of second predetermined evolution durations, and determining a duration difference between the two target second predetermined evolution durations; determining a phase difference between the corresponding phase values of the two target second predetermined evolution durations; and determining the phase change rate of the qubits under the any fifth magnetic flux pulse based on the phase difference and the duration difference.

In some embodiments, processor 1320 may also execute the program code of the following steps: the qubits are Fluxonium qubits.

Processor 1320 may call the information and application program stored in the memory through the transmission apparatus to execute the following steps: displaying a qubit selection control on an interactive interface; displaying target qubits on the interactive interface in response to the operation of the qubit selection control; receiving a decoherence time request for the target qubits; determining a decoherence time of the target qubits in response to the decoherence time request, the decoherence time being obtained based on a plurality of first predetermined evolution durations, and the values of dephasing factors corresponding to the plurality of first predetermined evolution durations, and the values of the dephasing factors corresponding to the plurality of first predetermined evolution durations being obtained after evolving the target qubits for the plurality of first predetermined evolution durations from a predetermined initial state; and displaying the decoherence time on the interactive interface.

It is appreciated that the structure shown in FIG. 13 is only a schematic diagram, and the computer terminal may also be a smart phone (such as an Android mobile phone, and an iOS mobile phone), a tablet computer, a palmtop, Mobile Internet Devices (MIDs), a PAD and other terminal devices. FIG. 13 does not limit the structure of the electronic apparatus. For example, computer terminal 1300 may further include more or less components (such as a network interface, and a display apparatus) than those shown in FIG. 13, or has different configurations from those shown in FIG. 13.

It is appreciated that all or part of the steps in the various methods of the above embodiments may be completed by instructing the hardware related to the terminal device through a program. The program may be stored in a computer readable storage medium, and the computer readable storage medium may include: a flash disk, a read-only memory (ROM), a random access memory (RAM), a magnetic disk or an optical disk, and the like.

Some embodiments of the present disclosure also provide a computer readable storage medium. In some embodiments, the computer readable storage medium may be configured to store the program code executed by the qubit processing method according to the embodiments of the present disclosure.

In some embodiments, the computer readable storage medium may be located in any computer terminal in the computer terminal group in the computer network, or in any mobile terminal in the mobile terminal group.

In some embodiments, the computer readable storage medium is set to store the program code for executing the following steps: acquiring values of dephasing factors corresponding to a plurality of first predetermined evolution durations after qubits are respectively evolved for the plurality of first predetermined evolution durations from a predetermined initial state; and determining a decoherence time of the qubits based on the plurality of first predetermined evolution durations and the values of the dephasing factors corresponding to the plurality of first predetermined evolution durations.

In some embodiments, the computer readable storage medium is set to store the program code for executing the following steps: acquiring the values of dephasing factors corresponding to a plurality of first predetermined evolution durations after qubits are respectively evolved for the plurality of first predetermined evolution durations from a predetermined initial state includes: for any one of the plurality of first predetermined evolution durations, after the qubits are evolved for the any first predetermined evolution duration from the predetermined initial state, applying a plurality of first magnetic flux pulses to the qubits for projection measurement to obtain first measurement results corresponding to the plurality of first magnetic flux pulses; acquiring the value of the dephasing factor corresponding to the any first predetermined evolution duration based on the first measurement results corresponding to the plurality of first magnetic flux pulses; and acquiring the values of the dephasing factors corresponding to the plurality of first predetermined evolution durations by a mode of acquiring the value of the dephasing factor corresponding to the any first predetermined evolution duration.

In some embodiments, the computer readable storage medium is set to store the program code for executing the following steps: the plurality of first magnetic flux pulses include three first magnetic flux pluses; and the corresponding phases of the three first magnetic flux pulses in projection measurement are sequentially spaced by approximately 120 degrees.

In some embodiments, the computer readable storage medium is set to store the program code for executing the following steps: before acquiring the values of dephasing factors corresponding to a plurality of first predetermined evolution durations after qubits are respectively evolved for the plurality of first predetermined evolution durations from a predetermined initial state, the method includes: determining a fixed evolution duration, and a second magnetic flux pulse; determining a plurality of third magnetic flux pulses comprising the second magnetic flux pulse within a predetermined range around the second magnetic flux pulse; after the qubits are evolved for the fixed evolution duration from the predetermined initial state, respectively applying the plurality of third magnetic flux pulses to the qubits for projection measurement so as to obtain candidate values of the dephasing factors corresponding to the plurality of three magnetic flux pulses; selecting the third magnetic flux pulse having the largest candidate value of the dephasing factor from the plurality of third magnetic flux pulses as a target magnetic flux pulse; and fixing the qubits under the target magnetic flux pulse, and respectively evolving the qubits for the plurality of first predetermined evolution durations from the predetermined initial state.

In some embodiments, the computer readable storage medium is set to store the program code for executing the following steps: acquiring a first relationship curve between the dephasing factors and the durations based on the plurality of first predetermined evolution durations and the values of the dephasing factors corresponding to the plurality of first predetermined evolution durations; and determining a decoherence time of the qubits based on the first relationship curve.

In some embodiments, the computer readable storage medium is set to store the program code for executing the following steps: acquiring a first relationship curve between the dephasing factors and the durations based on the plurality of first predetermined evolution durations and the values of the dephasing factors corresponding to the plurality of first predetermined evolution durations includes: determining the number of the plurality of first predetermined evolution durations, and a first fitting function; and acquiring the first relationship curve between the dephasing factors and the durations by using the first fitting function based on the number of first predetermined evolution durations and the values of the dephasing factors corresponding to the number of first predetermined evolution durations.

In some embodiments, the computer readable storage medium is set to store the program code for executing the following steps: determining a decoherence time of the qubits based on the first relationship curve includes: determining a target value of the dephasing factors; and determining the duration corresponding to the target value as the decoherence time of the qubits on the first relationship curve.

In some embodiments, the computer readable storage medium is set to store the program code for executing the following steps: after determining a decoherence time of the qubits based on the plurality of first predetermined evolution durations and the values of the dephasing factors corresponding to the plurality of first predetermined evolution durations, the method further includes: acquiring values of the decoherence time by evolving the qubits under a plurality of fourth magnetic flux pulses respectively; and acquiring a second relationship curve between the decoherence time and the magnetic flux pulses based on the values of the decoherence time corresponding to the plurality of fourth magnetic flux pulses.

In some embodiments, the computer readable storage medium is set to store the program code for executing the following steps: acquiring corresponding initial frequencies of the qubits under a plurality of fifth magnetic flux pulses; acquiring phase change rates of the qubits when applying the plurality of fifth magnetic flux pulses respectively; acquiring frequency values corresponding to the plurality of fifth magnetic flux pulses based on the corresponding initial frequencies under the plurality of fifth magnetic flux pulses and the phase change rates corresponding to the plurality of fifth magnetic flux pulses, respectively; and acquiring a third relationship curve between the frequencies of the qubits and the magnetic flux pulses based on the plurality of fifth magnetic flux pulses and the frequency values corresponding to the plurality of fifth magnetic flux pulses.

In some embodiments, the computer readable storage medium is set to store the program code for executing the following steps: acquiring phase change rates of the qubits when applying the plurality of fifth magnetic flux pulses respectively includes: for any one of the plurality of fifth magnetic flux pulses, acquiring phase values of the qubits after evolving for a plurality of second predetermined evolution durations under the any fifth magnetic flux pulse; determining the phase change rate of the qubits under the any fifth magnetic flux pulse based on the plurality of second predetermined evolution durations and the phase values corresponding to the plurality of second predetermined evolution durations; and acquiring the phase change rates of the qubits when applying the plurality of fifth magnetic flux pulses by the mode of acquiring the phase change rate of the any fifth magnetic flux pulse.

In some embodiments, the computer readable storage medium is set to store the program code for executing the following steps: acquiring phase values of the qubits after evolving for a plurality of second predetermined evolution durations under any fifth magnetic flux pulse includes: for any one of the plurality of second predetermined evolution durations, determining a sixth magnetic flux pulse corresponding to the any fifth magnetic flux pulse, the sixth magnetic flux pulse having an amplitude the same as that of the any fifth magnetic flux pulse, but having a different corresponding phase for projection measurement; after the evolution of the qubits for any second predetermined evolution duration from the predetermined initial state, respectively applying the any fifth magnetic flux pulse and the sixth magnetic flux pulse to the qubits for projection measurement so as to obtain a second measurement result of the any fifth magnetic flux pulse and a third measurement result corresponding to the sixth magnetic flux pulse; acquiring the phase value corresponding to the any second predetermined evolution duration based on the second measurement result of the any fifth magnetic flux pulse and the third measurement result corresponding to the sixth magnetic flux pulse; and acquiring the phase value of the qubits after evolving for the plurality of second predetermined evolution durations under the any fifth magnetic flux pulse respectively by the mode of acquiring the phase value corresponding to the any second predetermined evolution duration.

In some embodiments, the computer readable storage medium is set to store the program code for executing the following steps: determining the phase change rate of the qubits under the any fifth magnetic flux pulse based on the plurality of second predetermined evolution durations and the phase values corresponding to the plurality of second predetermined evolution durations includes: selecting two target second predetermined evolution durations from the plurality of second predetermined evolution durations, and determining a duration difference between the two target second predetermined evolution durations; determining a phase difference between the corresponding phase values of the two target second predetermined evolution durations; and determining the phase change rate of the qubits under the any fifth magnetic flux pulse based on the phase difference and the duration difference.

In some embodiments, the computer readable storage medium is set to store the program code for executing the following steps: the qubits are Fluxonium qubits.

In some embodiments, the computer readable storage medium is set to store the program code for executing the following steps: displaying a qubit selection control on an interactive interface; displaying target qubits on the interactive interface in response to the operation of the qubit selection control; receiving a decoherence time request for the target qubits; determining a decoherence time of the target qubits in response to the decoherence time request, the decoherence time being obtained based on a plurality of first predetermined evolution durations, and the values of dephasing factors corresponding to the plurality of first predetermined evolution durations, and the values of the dephasing factors corresponding to the plurality of first predetermined evolution durations being obtained after evolving the target qubits for the plurality of first predetermined evolution durations from a predetermined initial state; and displaying the decoherence time on the interactive interface.

The embodiments may further be described using the following clauses:
1. A qubit processing method, comprising:
acquiring values of dephasing factors corresponding to a plurality of first predetermined evolution durations after a qubit is respectively evolved for the plurality of first predetermined evolution durations from a predetermined initial state; and
determining a decoherence time of the qubit based on the plurality of first predetermined evolution durations and the values of the dephasing factors corresponding to the plurality of first predetermined evolution durations.
2. The method according to clause 1, wherein acquiring the values of dephasing factors corresponding to a plurality of first predetermined evolution durations after the qubit is respectively evolved for the plurality of first predetermined evolution durations from the predetermined initial state comprises:
for any one of the plurality of first predetermined evolution durations, after the qubit is evolved for the any one of the plurality of first predetermined evolution durations from the predetermined initial state, applying a plurality of first magnetic flux pulses to the qubit for projection measurement to obtain a plurality of first measurement results corresponding to the plurality of first magnetic flux pulses;
acquiring a value of a dephasing factor corresponding to the any one of the plurality of first predetermined evolution duration based on the plurality of first measurement results corresponding to the plurality of first magnetic flux pulses; and
acquiring the values of the dephasing factors corresponding to the plurality of first predetermined evolution durations by a mode of acquiring the value of the dephasing factor corresponding to the any first predetermined evolution duration.
3. The method according to clause 2, wherein the plurality of first magnetic flux pulses comprise three first magnetic flux pluses; and corresponding phases of the three first magnetic flux pulses in projection measurement are sequentially spaced by approximately 120 degrees.
4. The method according to clause 1, wherein before acquiring the values of dephasing factors corresponding to the plurality of first predetermined evolution durations after the qubit is respectively evolved for the plurality of first predetermined evolution durations from a predetermined initial state, the method comprises:
determining a fixed evolution duration and a second magnetic flux pulse;
determining a plurality of third magnetic flux pulses comprising the second magnetic flux pulse within a predetermined range around the second magnetic flux pulse;
after the qubit is evolved for the fixed evolution duration from the predetermined initial state, respectively applying the plurality of third magnetic flux pulses to the qubit for projection measurement to obtain a plurality of candidate values of the dephasing factors corresponding to the plurality of third magnetic flux pulses;
selecting a third magnetic flux pulse having the largest candidate value of the dephasing factor from the plurality of third magnetic flux pulses as a target magnetic flux pulse; and
fixing the qubit under the target magnetic flux pulse, and respectively evolving the qubit for the plurality of first predetermined evolution durations from the predetermined initial state.
5. The method according to clause 1, wherein determining a decoherence time of the qubit based on the plurality of first predetermined evolution durations and the values of the dephasing factors corresponding to the plurality of first predetermined evolution durations comprises:
acquiring a first relationship curve between the dephasing factors and the durations based on the plurality of first predetermined evolution durations and the values of the dephasing factors corresponding to the plurality of first predetermined evolution durations; and
determining a decoherence time of the qubit based on the first relationship curve.
6. The method according to clause 5, wherein acquiring a first relationship curve between the dephasing factors and the durations based on the plurality of first predetermined evolution durations and the values of the dephasing factors corresponding to the plurality of first predetermined evolution durations comprises:
determining a number of the plurality of first predetermined evolution durations, and a first fitting function; and
acquiring the first relationship curve between the dephasing factors and the durations by using the first fitting function based on the number of first predetermined evolution durations and the values of the dephasing factors corresponding to the number of first predetermined evolution durations.
7. The method according to clause 5, wherein determining the decoherence time of the qubit based on the first relationship curve comprises:
determining a target value of the dephasing factors; and
determining the duration corresponding to the target value as the decoherence time of the qubit on the first relationship curve.
8. The method according to clause 1, wherein after determining a decoherence time of the qubit based on the plurality of first predetermined evolution durations and the values of the dephasing factors corresponding to the plurality of first predetermined evolution durations, the method further comprises:
acquiring values of the decoherence time by evolving the qubit under a plurality of fourth magnetic flux pulses respectively; and
acquiring a second relationship curve between the decoherence time and the magnetic flux pulses based on the values of the decoherence time corresponding to the plurality of fourth magnetic flux pulses.
9. The method according to clause 1, further comprising:
acquiring corresponding initial frequencies of the qubit under a plurality of fifth magnetic flux pulses;
acquiring a plurality of phase change rates of the qubit when applying the plurality of fifth magnetic flux pulses respectively;
acquiring frequency values corresponding to the plurality of fifth magnetic flux pulses based on the corresponding initial frequencies under the plurality of fifth magnetic flux pulses and the plurality of phase change rates corresponding to the plurality of fifth magnetic flux pulses respectively; and
acquiring a third relationship curve between the frequencies of the qubit and the magnetic flux pulses based on the plurality of fifth magnetic flux pulses and the frequency values corresponding to the plurality of fifth magnetic flux pulses.
10. The method according to clause 9, wherein acquiring the plurality of phase change rates of the qubit when applying the plurality of fifth magnetic flux pulses respectively comprises:
for any one of the plurality of fifth magnetic flux pulses, acquiring a plurality of phase values of the qubit after evolving for a plurality of second predetermined evolution durations under the any one of the plurality of fifth magnetic flux pulses;
determining a plurality of phase change rate of the qubit under the any one of the plurality of fifth magnetic flux pulses based on the plurality of second predetermined evolution durations and the phase values corresponding to the plurality of second predetermined evolution durations; and
acquiring the plurality of phase change rates of the qubit when applying the plurality of fifth magnetic flux pulses on the qubit by a mode of acquiring the phase change rate of the any one of the plurality of fifth magnetic flux pulses.
11. The method according to clause 10, wherein acquiring the plurality of phase values of the qubit after evolving for a plurality of second predetermined evolution durations under any one of the plurality of fifth magnetic flux pulses comprises:
for any one of the plurality of second predetermined evolution durations, determining a sixth magnetic flux pulse corresponding to the any one of the plurality of fifth magnetic flux pulses, the sixth magnetic flux pulse having an amplitude the same as that of the any one of the plurality of fifth magnetic flux pulses, but having a different corresponding phase for projection measurement;
after the evolution of the qubit for any second predetermined evolution duration from the predetermined initial state, respectively applying the any one of the plurality of fifth magnetic flux pulses and the sixth magnetic flux pulse to the qubit for projection measurement to obtain a second measurement result of the any one of the plurality of fifth magnetic flux pulses and a third measurement result corresponding to the sixth magnetic flux pulse;
acquiring a phase value corresponding to the any second predetermined evolution duration based on the second measurement result of the any one of the plurality of fifth magnetic flux pulses and a third measurement result corresponding to the sixth magnetic flux pulse; and
acquiring the phase value of the qubit after evolving for the plurality of second predetermined evolution durations under the any one of the plurality of fifth magnetic flux pulses respectively by the mode of acquiring the phase value corresponding to the any second predetermined evolution duration.
12. The method according to clause 10, wherein determining the phase change rate of the qubit under the any one of the plurality of fifth magnetic flux pulses based on the plurality of second predetermined evolution durations and the phase values corresponding to the plurality of second predetermined evolution durations comprises:
selecting two target second predetermined evolution durations from the plurality of second predetermined evolution durations, and determining a duration difference between the two target second predetermined evolution durations;
determining a phase difference between the corresponding phase values of the two target second predetermined evolution durations; and
determining the phase change rate of the qubit under the any one of the plurality of fifth magnetic flux pulses based on the phase difference and the duration difference.
13. The method according to any one of clauses 1 to 12, wherein the qubit is a Fluxonium qubit.
14. A qubit processing method, comprising:
displaying a qubit selection control on an interactive interface;
displaying a target qubit on the interactive interface in response to the operation of the qubit selection control;
receiving a decoherence time request for the target qubit;
determining a decoherence time of the target qubit in response to the decoherence time request, the decoherence time being obtained based on a plurality of first predetermined evolution durations, and the values of dephasing factors corresponding to the plurality of first predetermined evolution durations, and the values of the dephasing factors corresponding to the plurality of first predetermined evolution durations being obtained after evolving the target qubit for the plurality of first predetermined evolution durations from a predetermined initial state; and
displaying the decoherence time on the interactive interface.
15. A computer readable storage medium, comprising a stored program, wherein the program in running controls a device with the computer readable storage medium to execute the qubit processing method according to any one of clauses 1 to 14.
16. A computer device, comprising a memory and a processor, wherein
the memory is configured to store a computer program; and
the processor is configured to execute the computer program stored in the memory, and the processor executes the qubit processing method according to any one of clauses 1 to 14 when the computer program is running.
the processor is configured to execute the computer program stored in the memory, and the processor executes the qubit processing method according to any one of clauses 1 to 14 when the computer program is running. It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It should be understood that the disclosed technical content may be implemented in other ways. The apparatus embodiments described above are only schematic. For example, the division of the units is only a logical function division. In actual implementations, there may be another division manner. For example, multiple units or components may be combined or integrated into another system, or some features can be ignored or not implemented. In addition, the displayed or discussed mutual coupling or direct coupling or communication connection may be indirect coupling or communication connection through some interfaces, units, or modules, which may be in electrical or other forms.

The units described as separate components may or may not be physically separated, and the components displayed as units may or may not be physical units, that is, they may be located in one place or may be distributed to a plurality of network units. Part of or all the units may be selected according to actual needs to achieve the purpose of the solution of the present embodiment.

In addition, the functional units in various embodiments of the present disclosure may be integrated into one processing unit, or each unit may exist alone physically, or two or more units may be integrated into one unit. The integrated units described above may be implemented either in the form of hardware or in the form of a software functional unit.

If the integrated units are implemented in the form of a software functional unit and sold or used as an independent product, they may be stored in a quantum computer-readable storage medium. Based on such an understanding, the technical solutions of the present disclosure essentially, or the part making contributions to the prior art, or all or part of the technical solutions may be embodied in the form of a software product. The quantum computer software product is stored in a storage medium and includes several instructions used for causing a quantum computer device to execute all or part of steps of the methods in various embodiments of the present disclosure.

The above are only preferred implementations of the present disclosure. It should be pointed out that, for those of ordinary skill in the art, several improvements and retouches may further be made without departing from the principles of the present disclosure. These improvements and retouches should also be regarded as the scope of protection of the present specification.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A qubit processing method, comprising:
acquiring values of dephasing factors corresponding to a plurality of first predetermined evolution durations after a qubit is respectively evolved for the plurality of first predetermined evolution durations from a predetermined initial state; and
determining a decoherence time of the qubit based on the plurality of first predetermined evolution durations and the values of the dephasing factors corresponding to the plurality of first predetermined evolution durations.

2. The method according to claim 1, wherein acquiring the values of dephasing factors corresponding to a plurality of first predetermined evolution durations after the qubit is respectively evolved for the plurality of first predetermined evolution durations from the predetermined initial state comprises:
for any one of the plurality of first predetermined evolution durations, after the qubit is evolved for the any one of the plurality of first predetermined evolution durations from the predetermined initial state, applying a plurality of first magnetic flux pulses to the qubit for projection measurement to obtain a plurality of first measurement results corresponding to the plurality of first magnetic flux pulses;
acquiring a value of a dephasing factor corresponding to the any one of the plurality of first predetermined evolution duration based on the plurality of first measurement results corresponding to the plurality of first magnetic flux pulses; and
acquiring the values of the dephasing factors corresponding to the plurality of first predetermined evolution durations by a mode of acquiring the value of the dephasing factor corresponding to the any first predetermined evolution duration.

3. The method according to claim 2, wherein the plurality of first magnetic flux pulses comprise three first magnetic flux pluses; and corresponding phases of the three first magnetic flux pulses in projection measurement are sequentially spaced by approximately 120 degrees.

4. The method according to claim 1, wherein before acquiring the values of dephasing factors corresponding to the plurality of first predetermined evolution durations after the qubit is respectively evolved for the plurality of first predetermined evolution durations from a predetermined initial state, the method comprises:
determining a fixed evolution duration and a second magnetic flux pulse;
determining a plurality of third magnetic flux pulses comprising the second magnetic flux pulse within a predetermined range around the second magnetic flux pulse;
after the qubit is evolved for the fixed evolution duration from the predetermined initial state, respectively applying the plurality of third magnetic flux pulses to the qubit for projection measurement to obtain a plurality of candidate values of the dephasing factors corresponding to the plurality of third magnetic flux pulses;
selecting a third magnetic flux pulse having the largest candidate value of the dephasing factor from the plurality of third magnetic flux pulses as a target magnetic flux pulse; and
fixing the qubit under the target magnetic flux pulse, and respectively evolving the qubit for the plurality of first predetermined evolution durations from the predetermined initial state.

5. The method according to claim 1, wherein determining a decoherence time of the qubit based on the plurality of first predetermined evolution durations and the values of the dephasing factors corresponding to the plurality of first predetermined evolution durations comprises:
acquiring a first relationship curve between the dephasing factors and the durations based on the plurality of first predetermined evolution durations and the values of the dephasing factors corresponding to the plurality of first predetermined evolution durations; and
determining a decoherence time of the qubit based on the first relationship curve.

6. The method according to claim 5, wherein acquiring a first relationship curve between the dephasing factors and the durations based on the plurality of first predetermined evolution durations and the values of the dephasing factors corresponding to the plurality of first predetermined evolution durations comprises:
determining a number of the plurality of first predetermined evolution durations, and a first fitting function; and
acquiring the first relationship curve between the dephasing factors and the durations by using the first fitting function based on the number of first predetermined evolution durations and the values of the dephasing factors corresponding to the number of first predetermined evolution durations.

7. The method according to claim 5, wherein determining the decoherence time of the qubit based on the first relationship curve comprises:
determining a target value of the dephasing factors; and
determining the duration corresponding to the target value as the decoherence time of the qubit on the first relationship curve.

8. The method according to claim 1, wherein after determining the decoherence time of the qubit based on the plurality of first predetermined evolution durations and the values of the dephasing factors corresponding to the plurality of first predetermined evolution durations, the method further comprises:
acquiring values of the decoherence time by evolving the qubit under a plurality of fourth magnetic flux pulses respectively; and
acquiring a second relationship curve between the decoherence time and the magnetic flux pulses based on the values of the decoherence time corresponding to the plurality of fourth magnetic flux pulses.

9. The method according to claim 1, further comprising:
acquiring corresponding initial frequencies of the qubit under a plurality of fifth magnetic flux pulses;
acquiring a plurality of phase change rates of the qubit when applying the plurality of fifth magnetic flux pulses respectively;
acquiring frequency values corresponding to the plurality of fifth magnetic flux pulses based on the corresponding initial frequencies under the plurality of fifth magnetic flux pulses and the plurality of phase change rates corresponding to the plurality of fifth magnetic flux pulses respectively; and
acquiring a third relationship curve between the frequencies of the qubit and the magnetic flux pulses based on the plurality of fifth magnetic flux pulses and the frequency values corresponding to the plurality of fifth magnetic flux pulses.

10. The method according to claim 9, wherein acquiring the plurality of phase change rates of the qubit when applying the plurality of fifth magnetic flux pulses respectively comprises:
for any one of the plurality of fifth magnetic flux pulses, acquiring a plurality of phase values of the qubit after evolving for a plurality of second predetermined evolution durations under the any one of the plurality of fifth magnetic flux pulses;
determining a plurality of phase change rate of the qubit under the any one of the plurality of fifth magnetic flux pulses based on the plurality of second predetermined evolution durations and the phase values corresponding to the plurality of second predetermined evolution durations; and
acquiring the plurality of phase change rates of the qubit when applying the plurality of fifth magnetic flux pulses on the qubit by a mode of acquiring the phase change rate of the any one of the plurality of fifth magnetic flux pulses.

11. The method according to claim 10, wherein acquiring the plurality of phase values of the qubit after evolving for a plurality of second predetermined evolution durations under any one of the plurality of fifth magnetic flux pulses comprises:
for any one of the plurality of second predetermined evolution durations, determining a sixth magnetic flux pulse corresponding to the any one of the plurality of fifth magnetic flux pulses, the sixth magnetic flux pulse having an amplitude the same as that of the any one of the plurality of fifth magnetic flux pulses, but having a different corresponding phase for projection measurement;
after the evolution of the qubit for any second predetermined evolution duration from the predetermined initial state, respectively applying the any one of the plurality of fifth magnetic flux pulses and the sixth magnetic flux pulse to the qubit for projection measurement to obtain a second measurement result of the any one of the plurality of fifth magnetic flux pulses and a third measurement result corresponding to the sixth magnetic flux pulse;
acquiring a phase value corresponding to the any second predetermined evolution duration based on the second measurement result of the any one of the plurality of fifth magnetic flux pulses and a third measurement result corresponding to the sixth magnetic flux pulse; and
acquiring the phase value of the qubit after evolving for the plurality of second predetermined evolution durations under the any one of the plurality of fifth magnetic flux pulses respectively by the mode of acquiring the phase value corresponding to the any second predetermined evolution duration.

12. The method according to claim 10, wherein determining the phase change rate of the qubit under the any one of the plurality of fifth magnetic flux pulses based on the plurality of second predetermined evolution durations and the phase values corresponding to the plurality of second predetermined evolution durations comprises:
selecting two target second predetermined evolution durations from the plurality of second predetermined evolution durations, and determining a duration difference between the two target second predetermined evolution durations;
determining a phase difference between the corresponding phase values of the two target second predetermined evolution durations; and
determining the phase change rate of the qubit under the any one of the plurality of fifth magnetic flux pulses based on the phase difference and the duration difference.

13. The method according to claim 1, wherein the qubit is a Fluxonium qubit.

14. A non-transitory computer readable medium that stores a set of instructions that is executable by one or more processors of an apparatus to cause the apparatus to perform operations comprising:
acquiring values of dephasing factors corresponding to a plurality of first predetermined evolution durations after a qubit is respectively evolved for the plurality of first predetermined evolution durations from a predetermined initial state; and
determining a decoherence time of the qubit based on the plurality of first predetermined evolution durations and the values of the dephasing factors corresponding to the plurality of first predetermined evolution durations.

15. The non-transitory computer readable medium according to claim 14, wherein the operations further comprise:
for any one of the plurality of first predetermined evolution durations, after the qubit is evolved for the any first predetermined evolution duration from the predetermined initial state, applying a plurality of first magnetic flux pulses to the qubit for projection measurement to obtain a plurality of first measurement results corresponding to the plurality of first magnetic flux pulses;
acquiring a value of the dephasing factor corresponding to the any first predetermined evolution duration based on the first measurement results corresponding to the plurality of first magnetic flux pulses; and
acquiring the values of the dephasing factors corresponding to the plurality of first predetermined evolution durations by a mode of acquiring the value of the dephasing factor corresponding to the any first predetermined evolution duration.

16. The non-transitory computer readable medium according to claim 14, wherein the operations further comprise:
determining a fixed evolution duration and a second magnetic flux pulse;
determining a plurality of third magnetic flux pulses comprising the second magnetic flux pulse within a predetermined range around the second magnetic flux pulse;
after the qubit is evolved for the fixed evolution duration from the predetermined initial state, respectively applying the plurality of third magnetic flux pulses to the qubit for projection measurement to obtain a plurality of candidate values of the dephasing factors corresponding to the plurality of third magnetic flux pulses;
selecting the third magnetic flux pulse having the largest candidate value of the dephasing factor from the plurality of third magnetic flux pulses as a target magnetic flux pulse; and
fixing the qubit under the target magnetic flux pulse, and respectively evolving the qubit for the plurality of first predetermined evolution durations from the predetermined initial state.

17. An apparatus for qubit processing, the apparatus comprising:
a memory configured to store instructions; and
one or more processors configured to execute the instructions to cause the apparatus to perform:
acquiring values of dephasing factors corresponding to a plurality of first predetermined evolution durations after a qubit is respectively evolved for the plurality of first predetermined evolution durations from a predetermined initial state; and
determining a decoherence time of the qubit based on the plurality of first predetermined evolution durations and the values of the dephasing factors corresponding to the plurality of first predetermined evolution durations.

18. The apparatus according to claim 17, wherein the one or more processors are further configured to execute the instructions to cause the apparatus to perform:
for any one of the plurality of first predetermined evolution durations, after the qubit is evolved for the any first predetermined evolution duration from the predetermined initial state, applying a plurality of first magnetic flux pulses to the qubit for projection measurement to obtain a plurality of first measurement results corresponding to the plurality of first magnetic flux pulses;
acquiring a value of the dephasing factor corresponding to the any first predetermined evolution duration based on the first measurement results corresponding to the plurality of first magnetic flux pulses; and
acquiring the values of the dephasing factors corresponding to the plurality of first predetermined evolution durations by a mode of acquiring the value of the dephasing factor corresponding to the any first predetermined evolution duration

19. The apparatus according to claim 17, wherein the one or more processors are further configured to execute the instructions to cause the apparatus to perform:
determining a fixed evolution duration and a second magnetic flux pulse;
determining a plurality of third magnetic flux pulses comprising the second magnetic flux pulse within a predetermined range around the second magnetic flux pulse;
after the qubit is evolved for the fixed evolution duration from the predetermined initial state, respectively applying the plurality of third magnetic flux pulses to the qubit for projection measurement to obtain a plurality of candidate values of the dephasing factors corresponding to the plurality of third magnetic flux pulses;
selecting the third magnetic flux pulse having the largest candidate value of the dephasing factor from the plurality of third magnetic flux pulses as a target magnetic flux pulse; and
fixing the qubit under the target magnetic flux pulse, and respectively evolving the qubit for the plurality of first predetermined evolution durations from the predetermined initial state.

20. The apparatus according to claim 17, wherein the one or more processors are further configured to execute the instructions to cause the apparatus to perform:
acquiring a first relationship curve between the dephasing factors and the durations based on the plurality of first predetermined evolution durations and the values of the dephasing factors corresponding to the plurality of first predetermined evolution durations; and
determining a decoherence time of the qubit based on the first relationship curve.
